(19) United States
(12) Patent Application Publication
(10) Pub. No.: US 2002/0049076 A1
(43) Pub. Date: Apr. 25, 2002

(54) Wide-area-network wireless modem with embedded communication protocol

(76) Inventors: Charles K. Jones, Anaheim, CA (US); Craig Counts, Orange, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/888,335

(22) Filed: Jun. 22, 2001

Related U.S. Application Data
(60) Provisional application No. 60/213,816, filed on Jun. 23, 2000.

(51) Int. Cl. H04M 1/00

(52) U.S. Cl. 455/557; 455/422

(57) ABSTRACT

A wireless modem is connectable to a user device, in which application software is “wireless unaware” and does not require an application programmer to consider particularities of wireless communication protocols, via a serial port. The serial port of the wireless modem receives user data transmitted by the user device in accordance with a communications protocol for wireline transmission. An output port of the modem is connectable to an antenna. A processing unit is coupled to the serial port and the output port and includes an embedded communication protocol for wireless data communication. The processing unit processes the user data received from the serial port in accordance with the embedded communication protocol.

This application claims priority under 35 U.S.C. §119(e) to U.S. provisional patent application Ser. No. 60/213,816, filed Jun. 23, 2000.

### BACKGROUND OF THE INVENTION

1. Field of the Invention

The invention relates to wireless communication systems. More particularly, the invention relates to a modem and a method of transmitting and receiving data in a wireless communication system.

2. Description of the Related Art

A conventional modem is typically installed within, or connectable to a computer system and connectable to a telephone line to communicate with a remote computer system, for example, via the public telephone network or via a local or wide-area network. A “wireless” modem is also connectable to a computer system, but communicates with a remote computer system via a wireless communication system. For example, a wireless modem may operate in a network known as Mobitex and operated by Cingular Interactive. The Mobitex network is a two-way packet-switched, narrowband PCS network designed for wide-area wireless data communications. Each wireless modem in a Mobitex network is assigned a unique access number, which identifies a wireless modem. A wireless modem may also operate in other wide-area wireless data networks. Examples of such networks are known as Datatac, Aeris Microburst/VBurst, Cellular Digital Packet Data (CDPD) or Nextel.

The wireless modems operating in these networks require that complex communication protocols be embedded within the computer system that needs to transmit data to the wireless modem. This requires the computer application software to incorporate these communication protocols, thus becoming “wireless-aware.”

### SUMMARY OF THE INVENTION

The preferred embodiments of the present invention improve wireless communication systems, improve modems configured to operate in a wireless communication system and improve methods of transmitting data in a wireless communication system. These embodiments facilitate application developments and provide wireless communication capability even for lower-end computer systems.

An aspect of these embodiments is a modem configured to operate in a wireless communication system. A significant feature of the modem is that the modem includes embedded application software for wireless communication. A user device connectable to the modem is therefore “wireless unaware” and does not require an application programmer to consider the particularities of wireless communication protocols. That is, the “wireless unaware” user device simply sends user data to the modem using a communications protocol for wireline transmission.

The modem in accordance with the present invention advantageously avoids the disadvantages associated with implementing the wireless communication protocols in the user device. Incorporating the communication protocols within the computer application software of the user device significantly increases both the development time and cost, and may as well as introduce support issues after the development process is complete. Furthermore, lower-end computer systems may not have enough computing power to execute these complex communication protocols and still meet other system requirements making it impossible to implement wireless communication capability.

A significant feature of the present invention is that the modem can be used in a variety of applications within a wireless communication system. The user device and the modem may be mobile or installed at a fixed location. In an exemplary mobile application, the user may detach the user device from the modem and use the modem without the user device. In an exemplary installed application, the user device and the modem remain connected within an installation. The user device monitors the installation and reports predetermined events to the modem that forwards the reports via a radio message to a central server facility.

### BRIEF DESCRIPTION OF THE DRAWINGS

These and other aspects, advantages, and novel features of the invention will become apparent upon reading the following detailed description and upon reference to the accompanying drawings. In the drawings, same elements have the same reference numerals.

FIG. 1 is an illustration of a wireless communication system providing wireless two-way communication between a host computer system and a wireless modem coupled to a user device.

FIG. 2 is a flowchart of a procedure that monitors a serial port of the modem for incoming data and determines whether the modem receives data at the serial port.

FIG. 3 is a flowchart of a procedure that packetizes data prior to transmission.

FIG. 4 is a flowchart of a procedure that transmits data to the host computer system.

FIG. 5 is a flowchart of a procedure that processes a packet successfully received at the modem.

FIG. 6 is a flowchart of a procedure that transmits payload data obtained from a received packet to the user device.

FIG. 7 shows a block diagram of the wireless modem comprised in the wireless communication system.

### DETAILED DESCRIPTION OF THE PREFERRED EMBODIMENT

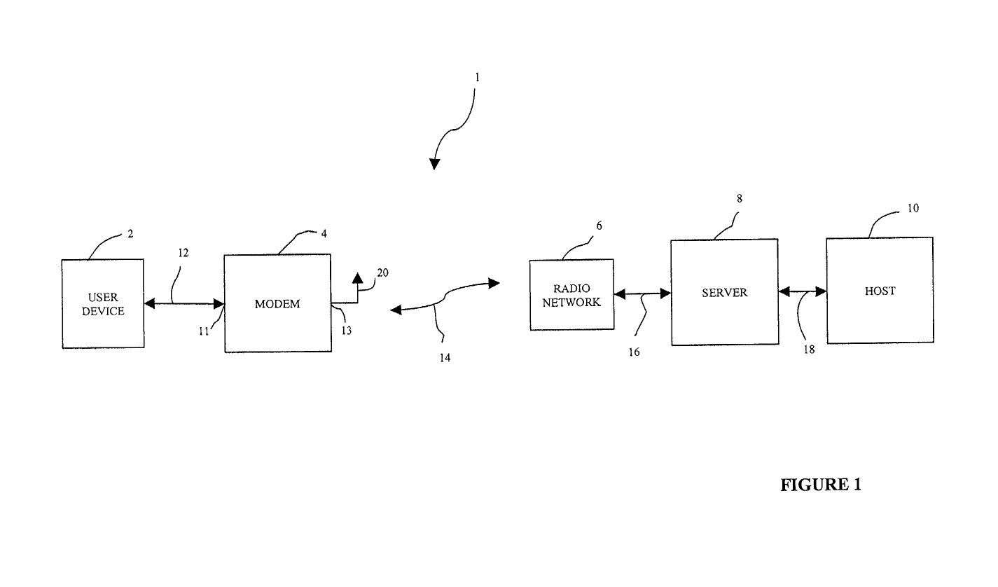

FIG. 1 depicts an exemplary wireless communication system 1 (“system 1”) in which the present invention is applicable. In one embodiment, the wireless communication system 1 is a wireless wide-area network (“WWAN”) data transmission system, e.g., a Mobitex network. However, it is contemplated that the present invention is equally applicable in networks other than WWAN'S, for example, wireless local area networks (WLAN).

The illustrated system 1 includes a user device 2 and a wireless modem 4 (“modem 4”) in accordance with the present invention. The user device 2 and the modem 4 are located on a client side and connected through a connection 12 that is connected to a serial port 11 of the modem 4. An antenna 20 is connected to an output port 13 of the modem 4.

A host side of the system 1 includes a host system comprising a server 8 of a service provider and a host computer 10. A connection 18 connects the server 8 and the host computer 10. The system 1 further includes a radio network 6 for wireless communication, such as radio transmitter base stations (“base stations”) and switching equipment. The radio network 6 allows wireless communications between the client side and the host side via a radio link 14. The wireless communications take place in accordance with defined wireless protocols, for example, a Mobitex Asynchronous Serial Communication (MASC) for a Mobitex network, or a Native Control Language (NCL) for a Datatac network. In one embodiment, equipment on the client-side device is responsible for monitoring the status of the radio network 6 and determining if the host side successfully received any transmitted data.

It is contemplated that the user device 2 and the modem 4 on the client side are mobile and may be carried by a user or mounted to vehicle. Further, the user may detach the user device 2 from the modem 4 and move around with the user device 2 while the modem 4 remains in the vehicle. The modem 4 has known functionalities that enable the modem 4 to communicate with the radio network 6. For example, the modem 4 includes hardware, such as a central processor unit, a radio frequency (RF) signal processing unit and an RF transceiver, and appropriate software to operate the modem 4 within the radio network 6. Among others, the modem 4 detects if the modem 4 is within or outside a coverage area of the radio network 6, performs automatic roaming, and sends and receives radio signals via the antenna 20. Further, if a data transmission fails, the modem 4 temporary stores the data and periodically attempts to re-send the data in accordance with network protocols.

In one embodiment, the modem 4 is based on a commercially available radio modem that is modified in accordance with the present invention. For example, the radio modem may be a RIM 902/802 radio modem available from Research In Motion Limited, Canada. A software developer's kit for the RIM 902 radio modem includes the tools for developing desired applications. The development environment uses Microsoft Developer Studio 5.0 or later, with Visual C++5.0 or later. The RIM 902/802 radio modem includes an application programming interface (“API”) that uses the radio modem's multitasking operating system to implement API functions such as serial communications API, database/file system API, radio API and system API. Further details of the radio modem are described in “Developer's Guide, RIM 902M Radio-Modem, Development API, Version 1.0,” the entire disclosure is herewith incorporated by reference, and attached as Appendix A.

In accordance with the present invention, the modem 4 includes embedded communication protocols, or libraries of protocols, also referred to as “middleware,” that enable the wireless communications of the modem 4. As the middleware is embedded in the modem 4 instead of in the user device 2, the user device 2 is “wireless unaware.” That is, the user device 2 simply transmits data to the modem 4 using communication protocols adapted for wireline transmission, also referred to as “wire-bound”. The modem 4, which is “wireless aware,” then processes the received data for a wireless transmission in accordance with the embedded middleware. One advantage of a “wireless unaware” user device 2 is that an application programmer of the user device 2 does not have to consider the particularities of the wireless communication protocols. Further, the absence of the complex wireless communication protocols from the user device 2 enables use of lower-end user devices for wireless applications.

In one of the preferred embodiments of this invention, the user device 2 is a computer system, such as a laptop computer, a personal digital assistant (PDA), a mobile data terminal, or any other device with a computer-like functionality and a communication port that is connectable to the serial port 11 of the modem 4. Advantageously, such computers or computer-like devices are portable. Thus, if the modem 4 is affixed within a vehicle, the user may advantageously disconnect the user device 2 from the modem 4 and use the user device 2 away from the vehicle and the modem 4. After use, the user can re-connect the user device 2 again to the modem 4. Once re-connected, the modem 4 receives the data stored in the user device 2 and automatically transmits the data stored during the external use to the server 8 or the host computer 10.

In another embodiment, the user device 2 and the modem 4 remain connected. The user device 2 may also be a computer system, for example, within a stationary production or service equipment. The user device 2 may monitor the status and performance of the equipment and periodically, or upon a triggered alert, send a message to a central station via the modem 4. For example, the service equipment may be a vending machine or an automatic teller machine (“ATM”). A triggering alert may be that the service equipment is running out of merchandise or cash. Additional applications of the modem 4 in accordance with the present invention are described below.

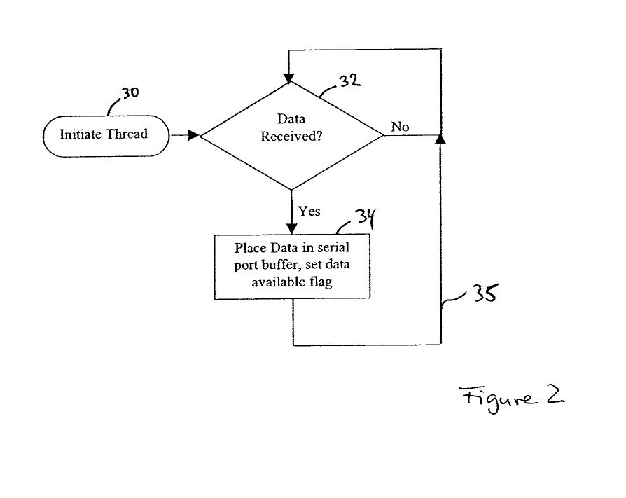

FIGS. 2, 3 and 4 are flowcharts of procedures illustrating the method in accordance with the present invention that transmit data from the client side to the host side of the system 1 shown in FIG. 1. When the user device 2 wishes to transmit data, the user device 2 sends the data to the modem 4 via the connection 12 for further processing. The software within the modem 4 is a multi-tasking, multi-thread design and will typically have several procedures or threads running.

FIG. 2 is a flowchart of a procedure that monitors the serial port 11 for incoming data and determines whether the modem 4 receives data at the serial port 11. In a step 30, e.g., when the user activates the modem 4 or connects the modem 4 to the user device 2, the procedure is initialized. The initialization procedure includes, among others, the step of determining whether the connection 12 is connected to the serial port 11.

In a step 32, upon receipt of data from the user device 2, the procedure proceeds along the YES branch to a step 34. In the absence of incoming data, however, the procedure pauses at the step 32 as indicated through the NO branch of the step 32.

In the step 34, the procedure temporarily stores the received data in a memory and posts a flag. The flag alerts the wireless protocol thread that data is present for transmission to the host side. During operation of the modem 4, the illustrated procedure is a continuous procedure as indicated through a path 35 that returns to the step 32.

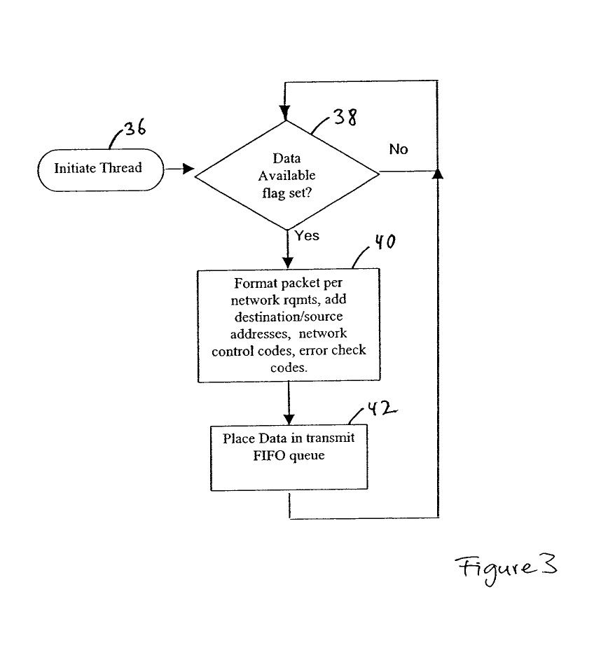

FIG. 3 is a flowchart of a procedure that packetizes the data for transmission. Upon initialization of the procedure in a step 36, the procedure proceeds to a step 38, in which the procedure periodically interrogates the memory whether a flag has been set during the procedure illustrated in FIG. 2. If no data is available, i.e., the flag is not set to “true,” the procedure waits until data is available as indicated through the NO branch in the step 38. If data is available, i.e., the flag is set to “true,” the procedure proceeds to a step 40.

In the step 40, the procedure retrieves the data and formats the retrieved data into a packet. The packet includes the retrieved data as payload data, a destination address, a source address, network control characters and error check characters as required. For example, in a Mobitex network, a packet has the following structure:

[SOURCE ADD] [DESTINATION ADD] [SUBSCRIPTION FLAG]

[EXTERNAL FLAG] [PACKET CLASS] [TYPE DEPENDENT COMPONENTS]

with:

SOURCE ADD=senders address

DESTINATION ADD=recipients address

SUBSCRIPTION FLAG=information regarding the packet

EXTERNAL FLAG=always 0, function not supported

PACKET CLASS=indicates packet type

TYPE DEPENDENT COMPONENTS=includes payload data.

In a step 42, the procedure places the packet in a first-in, first-out data transmit queue (hereinafter referred to as “FIFO”). Once the FIFO includes a packet, the procedure alerts a data transmission procedure that a packet is available for transmission to the host side.

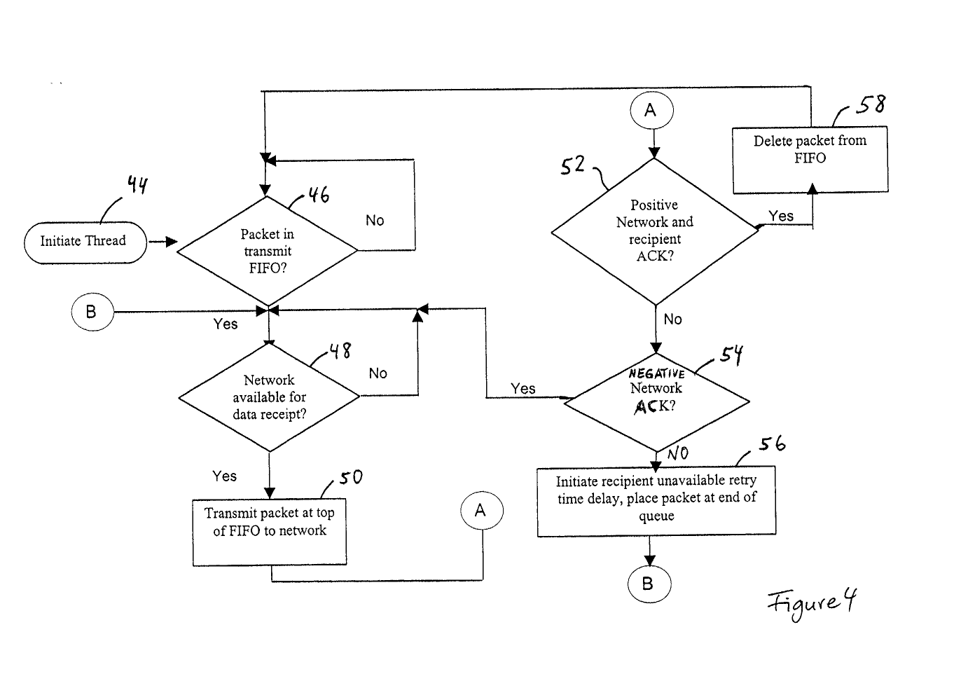

FIG. 4 is a flowchart of a procedure that transmits data to the host side. Upon initialization of the procedure, as shown in a step 44, the procedure waits until a packet is in the FIFO, as indicated through the NO branch of a step 46. If a packet is available, the procedure proceeds to a step 48.

In the step 48, the procedure determines the status of the radio network 6. If the radio network 6 is unavailable, the procedure waits as indicated through the NO branch of the step 48, and takes no action other than to periodically monitor the status of the radio network 6. If the procedure determines that the radio network 6 is available to receive data the procedure proceeds along the YES branch to a step 50.

In the step 50, the procedure transmits the packet at top of the FIFO to the radio network 6. The wireless transmission of the packet takes place between the modem 4 and the radio network 6 via the radio link 14. Once the radio network 6 receives the packet, a network connection 16 forwards the packet to the server 8 of a network service provider, referred to as Network Operations Center (NOC). From the NOC the packet is then transmitted through a network connection 18 to the recipient. In the illustrated embodiment, the recipient is a host computer 10. However, it is contemplated that in another embodiment, the recipient may be another wireless modem.

In steps 52 and 54, the procedure determines whether the data transmission was successful. The data transmit action may have one of three outcomes: the radio network 6 acknowledges the successful receipt of the packet, the radio network 6 provides a negative acknowledgement indicating that the packet was received but errors were encountered, or the radio network 6 acknowledges successful receipt of the packet, but reports that the radio network 6 cannot successfully transmit the packet to the recipient/host system.

In the step 52, if the data transmission was successful and the recipient and the radio network 6 acknowledged receipt of the packet, the procedure proceeds along the YES branch to a step 58. In the step 58, the procedure discards and deletes the successfully transmitted packet from the FIFO. The procedure then returns to the step 46. If the data transmission is not acknowledged as successful the procedure proceeds along the NO branch to the step 54.

In the step 54, upon a negative acknowledgement from the recipient and the radio network 6, the procedure determines whether the radio network 6 is still available to receive data. If the procedure determines a negative acknowledgement from the radio network 6, the procedure returns along the YES branch of the step 54 to the step 48. The procedure then re-transmits the packet to the radio network 6 until a positive acknowledgement is received. If the procedure determines a positive acknowledgement from the network, but a negative acknowledgement of packet delivery to the recipient, the procedure proceeds along the NO branch to a step 56.

In the step 56, the procedure determines that the recipient is unavailable. Further, the procedure removes the packet removed from the top of the FIFO and places the packet at the end of the FIFO. Most networks will require the sender to inhibit any further transmissions to that specific recipient for a specific time period to reduce network traffic. When this situation is encountered the software within the modem 4 can start a timer appropriate for the network in question. The procedure may then inhibit all transmissions until this timer expires. For example, in a Mobitex network the timer is set to two minutes, and in a Datatac network the timer is set to 15 minutes.

The steps 54, 56 are repeated should the modem 4 receive another negative acknowledgement of recipient reception. Once a transmission to the recipient is successful this sequence is exited and the packet transmission returns to normal. It is contemplated that while the procedure executes the steps 54, 56 all packets are stored in a non-volatile memory of the modem 4.

Thus, even if power is disconnected from the modem 4 the data will not be lost. Likewise, if the modem 4 is outside the coverage area of the radio network 6, the modem 4 will not be able to complete the data transmission. However, the modem 4 stores the data and sends the data as soon as the modem 4 is again within the coverage area of the radio network 6. This is particularly advantageous for mission-critical applications such as in an ambulance.

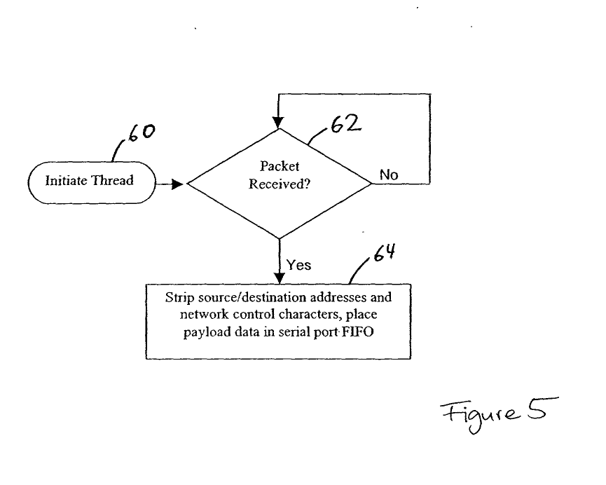

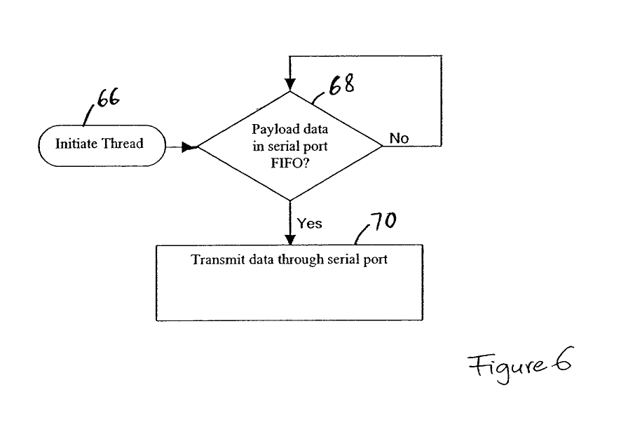

FIGS. 5 and 6 are flowcharts of procedures that relating to receiving data in the modem 4. That is, the host computer 10 transmits a packet via the connection 18 to the server 8 of the service provider (NOC). The server 8 maintains a network map that monitors which base station of the radio network 6 is assigned to each modem 4. Upon receipt of a data packet from the host computer 10, the server 8 inspects the packet, determines the address of the modem 4 and determines which base station is assigned to that specific modem 4. The server 8 then transmits the packet to the proper base station via the connection 16. The base station in turn attempts to transmit the packet to the modem 4.

There are three possible outcomes: the modem 4 can acknowledge receipt indicating the packet was received without errors. The modem 4 can provide a negative acknowledgement indicating the packet was received but contained errors, or the base station can receive no response from the modem 4. In a situation where the base station receives a positive acknowledgement, the packet has successfully been transmitted to the modem 4 and the base station discards the packet. In a situation where the base station receives a negative acknowledgement, the packet will be re-transmitted until the modem 4 provides a positive acknowledgement of receipt. If the base station receives no response, the base station will periodically re-attempt to deliver the packet. The base station attempts to re-deliver the packet for a predetermined time (dependant on the network parameters) and, if not successful, returns the packet to the server 8. The server 8 in turn notifies the sender, i.e., the host computer 10, that the packet could not be delivered to the recipient, the modem 4. The server 8 then discards the packet.

The procedure illustrated in FIG. 5, processes the packet successfully received in the modem 4. Upon initialization in a step 60, the procedure periodically monitors the serial port 11 of the modem 4 as indicated in a step 62. If a packet is present, the procedure proceeds along the YES branch to a step 64. Otherwise, the procedure remains at the step 62 as indicated through the NO branch.

In the step 64, once the packet is successfully received by the modem 4, the procedure removes addressing and network control characters from the packet. Further, the procedure stores the payload data in a serial data transport queue.

The procedure illustrated in FIG. 6 transmits the payload data to the user device 2. Upon initialization in a step 66, the procedure periodically monitors the serial port transport queue as indicated in a step 68. If a payload is present, the procedure proceeds along the YES branch to a step 70. Otherwise, the procedure remains at the step 68 as indicated through the NO branch.

In the step 70, the procedure retrieves the data from the serial port transport queue and transmits it to the user device 2 via the connection 12. In one embodiment, an error checking procedure may be omitted as the connection 12 is reliable. However, it is contemplated that in another embodiment, an error checking procedure may be provided.

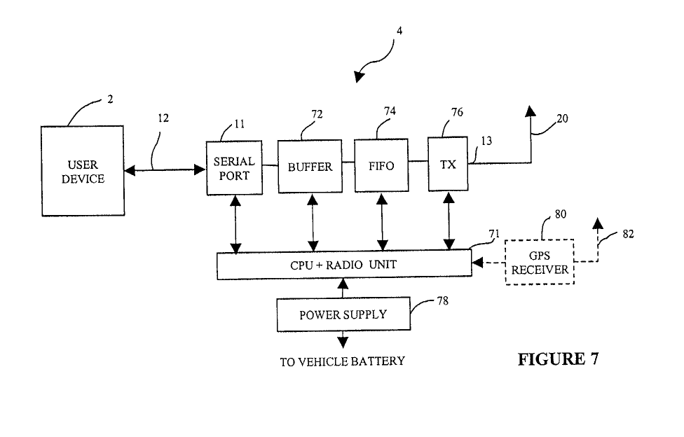

FIG. 7 shows a block diagram of the modem 4 comprised in the wireless communication system 1 shown in FIG. 1. The exemplary modem 4 includes a processing unit, which is illustrated as including a central processing unit (CPU) and radio unit 71. The CPU and radio unit 71 provides, among others, for the general functionality of a wireless modem. In addition, the modem 4 has components including the serial port 11, a buffer 72 as a non-volatile memory, a FIFO 74 and a transmitter 76 (TX). The CPU and radio unit 71 is coupled to these components in order to monitor and to control the components. In one embodiment, the serial port 11 is an ASCI compatible RS232 interface and a CMOS/RS232 level translator is interconnected between the serial port 11 and the CPU and radio unit 71. Further, power supply 78 provides power to the modem 4 and is connected to the CPU and radio unit 71.

In one embodiment, the modem 4 is based on a commercially available radio modem (e.g., RIM 902/802 radio modem) that is modified in accordance with the present invention. For example, the CPU and radio unit 71 may be part of the commercially available radio modem, wherein the CPU is configured to include the application middleware in accordance with the present invention. Thus, although FIG. 7 shows the buffer 72, the FIFO 74 and the transmitter 76 for illustrative purposes as separate components, it is contemplated that these components are in one embodiment part of the CPU and radio unit 71.

The power supply 78 is connected to a battery of a vehicle (not shown) in which the modem 4 is installed. The power supply 78 derives a DC voltage of about 4.7 volts from the vehicle battery of about 12 volts. The power supply 78 also protects the modem 4 from transient high-voltage spikes that may be generated by other electric components of the vehicle.

In one embodiment, the modem 4 may be combined with a receiver used in a global positioning system (“GPS”). It is contemplated that the GPS receiver connects to an internal serial port leaving the serial port 11 available for the user device 2. Advantageously, the GPS receiver is located within the modem 4 so that the GPS capable modem 4 is implemented in a single, compact housing. The GPS receiver generates input data that includes the geographical location of the GPS receiver, or the speed of a vehicle that carries the GPS receiver. As the GPS receiver is merely optional, FIG. 7 shows the GPS receiver through dashed lines. The GPS capable modem 4 transmits automatically or on demand from the server 8 the current location of the modem 4 to the server 8. The GPS capable modem 4 may therefore be used for automatic vehicle tracking.

For example, the automatic vehicle tracking may be used for pre-arrival notification of a warehouse, for example, to ensure that the gate is open and that personnel is available to unload the delivery truck. If necessary, the delivery route may be updated should a delay occur, advantageously under control of a central station.

In another example, while delivering a number of parcels to the customers within a commercial or residential building, the delivery man of a delivery service may use the user device 2 to log each parcel as delivered. As soon as the user device 2 is reconnected to the modem 4 within the delivery truck, the modem 4 transmits the logged data to a central station of the delivery service. If the modem 4 is GPS capable, the modem 4 may also transmit the current location of the delivery truck, indicate in which direction the truck moves, or indicate if the truck deviates from a predefined route.

While the above detailed description has shown, described and identified several novel features of the invention as applied to a preferred embodiment, it will be understood that various omission, substitutions and changes in the form and details of the described embodiment may be made by those skilled in the art without departing from the spirit of the invention. Accordingly, the scope of the invention should not be limited to the foregoing discussion, but should be defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A modem connectable to a portable or embedded computer in which application software is “wireless unaware” and does not require an application programmer to consider particularities of wireless communication protocols, the modem comprising:
a serial port connectable to a portable or embedded computer, the serial port configured to receive from the portable computer user data transmitted in accordance with a communication protocol for wireline transmission;
an output port connectable to an antenna; and
a processing unit coupled to the serial port and the output port and comprising an embedded communication protocol for wireless data communication over a predetermined radio network, the processing unit configured to process the user data received from the serial port in accordance with the embedded communication protocol.

2. A wireless communication system in which application software in a user computer is “wireless unaware” and does not require an application programmer to consider particularities of wireless communication protocols, the system comprising:
a user computer;
a modem connectable to the user computer, the modem comprising:
a serial port connectable to the user computer, the serial port configured to receive from the user computer user data transmitted in accordance with a communication protocol for wireline transmission;
an output port connectable to an antenna; and
a processing unit coupled to the serial port and the output port and comprising an embedded communication protocol for wireless data communication over a predetermined radio network, the processing unit configured to process the user data received from the serial port in accordance with the embedded communication protocol; and
a host system configured to communicate with the modem via a radio network.

3. A method of transmitting data in a wireless communication system in which application software in a user computer is “wireless unaware” and does not require an application programmer to consider particularities of wireless communication protocols, the method comprising:
transmitting user data in accordance with a communication protocol for wireline transmission to a wireless modem;
processing the user data within the wireless modem in accordance with an embedded communication protocol for wireless data communication over a predetermined radio network; and
transmitting the user data in accordance with the embedded communication protocol via a radio network to a host system.

4. A modem configured to operate in a wireless communication system, comprising:
a serial port connectable to a user device, the serial port configured to receive from the user device user data transmitted in accordance with a communication protocol for wireline transmission;
an output port connectable to an antenna; and
a processing unit coupled to the serial port and the output port and comprising an embedded communication protocol for wireless data communication, the processing unit configured to process the user data received from the serial port in accordance with the embedded communication protocol.

5. The modem of claim 1, further comprising a power supply connectable to an external power source.

6. The modem of claim 5, wherein the external power source is a battery of a vehicle.

7. The modem of claim 1, further comprising a receiver for a positioning system, the receiver being coupled to the processing unit and providing input data to the modem for transmission via the antenna.

8. The modem of claim 1, further comprising a buffer associated with the serial port and the processing unit, the buffer configured to store the user data received from the user device.

9. The modem of claim 8, wherein the processing unit obtains the user data from the buffer and packetizes the user data in accordance with a predetermined packet structure.

10. The modem of claim 9, further comprising a first-in, first-out (FIFO) memory associated with the buffer and the processing unit, the FIFO memory configured to store the packetized user data.

11. A wireless communications system, comprising:
a user device;
a modem connectable to the user device, the modem comprising:
a serial port connectable to the user device, the serial port configured to receive from the user device user data transmitted in accordance with a communications protocol for wireline transmission;
an output port connectable to an antenna; and
a processing unit coupled tot he serial port and the output port and comprising an embedded communication protocol for wireless data communication, the processing unit configured to process the user data received from the serial port in accordance with the embedded communication protocol; and
a host system configured to communicate with the modem via a radio network.

12. The system of claim 11, wherein the embedded communication protocol is configured for a predetermined radio network.

13. The system of claim 11, wherein the user device is portable and releasably connectable to the modem.

14. The system of claim 13, wherein the modem is located within a vehicle.

15. A method of transmitting data in a wireless communication system, comprising:
transmitting user data in accordance with a communication protocol for wireline transmission to a wireless modem;
converting the user data within the wireless modem in accordance with an embedded communication protocol for wireless data communication; and
transmitting the user data in accordance with the embedded communication protocol via a radio network to a host system.

16. The method of claim 15, further comprising monitoring a serial port of the modem for incoming user data.

17. The method of claim 16, further comprising setting a flag indicating that user data is available at the modem.

18. The method of claim 17, wherein converting the user data includes packetizing the user data in accordance with the embedded communication protocol.

19. The method of claim 18, wherein packetizing the user data includes at least adding a source address, a destination address, and the user data as payload.

20. The method of claim 19, further comprising storing a packet in a non-volatile memory within the modem.

21. The method of claim 20, further comprising detecting whether the modem receives an acknowledgement indicating that a transmitted packet has been received.

22. The method of claim 21, wherein detecting includes determining whether the radio network and the host system acknowledge receipt.

23. The method of claim 22, further comprising discarding the packet from the non-volatile memory upon an acknowledgment from the radio network and the host system.

24. The method of claim 16, further comprising, upon a negative acknowledgement from the radio network, determining if the radio network is available, and, upon confirmed availability, re-transmitting the packet.

25. The method of claim 16, further comprising, upon a negative acknowledgement from the host system, re-transmitting the packet to the host system upon expiration of a time.

26. The method of claim 16, further comprising indicating that the host system is unavailable, and placing the packet at an end of a transmit queue of the non-volatile memory.

27. The method of claim 15, further comprising receiving a packet at the modem from the host system via the radio network.

28. The method of claim 27, further comprising obtaining payload data from the packet by removing at least a source address and a destination address from the packet, and storing the payload data within the modem.

29. The method of claim 28, further comprising transmitting the payload data from the modem to the user device.
